(19) United States
(12) Patent Application Publication
(10) Pub. No.: US 2013/0339934 A1
(43) Pub. Date: Dec. 19, 2013

(54) UPDATING VIRTUALIZED SERVICES

(71) Applicants: Josef Troch, Pecky (CZ); Martin Pirchala, Kosice (SK); Martin Podval, Velky Osek (CZ)

(72) Inventors: Josef Troch, Pecky (CZ); Martin Pirchala, Kosice (SK); Martin Podval, Velky Osek (CZ)

(21) Appl. No.: 13/495,792

(22) Filed: Jun. 13, 2012

(51) Int. Cl. G06F 9/44

(52) U.S. Cl. 717/135

(57) ABSTRACT

A disclosed example method to update a virtualized service involves comparing at least one node of a first service schema to at least one node of a second service schema based on at least one criterion, and finding at least one change in the at least one node of the second service schema relative to the at least one node of the first service schema based on the at least one criterion. The example method also involves updating a first node of a first virtualized service with a processor and without user intervention based on the at least one change while maintaining an association between the first node of the first virtualized service and data previously associated with the first node.

### BACKGROUND

Service virtualization tools and products available today enable performing functional testing and/or performance testing of composite applications even if they correspond to services that are currently inaccessible (e.g., not yet implemented or accessible only a few hours per day), are third-party services (e.g., where a charge is incurred for every transaction), or are production services that cannot be easily tested or cannot be directly tested at all. Such prior service virtualization tools can be implemented by: (1) creating service simulation models by recording communications between a real service and its client(s), (2) writing simulation logic in a scripting language, or (3) creating a set of extensible markup language (XML) responses to be returned when a specific service request arrives. This enables a service virtualization tool to respond like a corresponding service the tool simulates.

### BRIEF DESCRIPTION OF THE DRAWINGS

FIG. 1A illustrates an example apparatus to analyze service schemas and update corresponding services based on changes in the service schemas.

FIG. 1B illustrates an example processor system that can be used to execute example instructions of FIGS. 8A and 8B to implement the example apparatus of FIG. 1A to analyze service schemas and update corresponding services based on changes in the service schemas.

FIGS. 2-6 illustrate results of example criteria-based analyses performed on service schemas to identify transformations to be applied to a corresponding virtualized service.

FIG. 7 illustrates an example manner of updating a simulation model of a virtualized service based on the criteria-based analyses results of FIGS. 2-6.

FIGS. 8A and 8B depict a flow diagram representative of example machine readable instructions to analyze nodes of service schemas and update a corresponding virtualized service based on changes between the service schemas.

### DETAILED DESCRIPTION

Example methods, apparatus, and articles of manufacture disclosed herein may be used to analyze service schemas and update corresponding virtualized services based on changes in the service schemas. Service simulation and virtualization tools are increasingly used by more and more companies to perform composite application testing. Hewlett Packard (HP) Service Virtualization is one such tool, which helps application developers lower development costs and improve the overall quality of their applications. A service typically has a service interface or a service schema that defines how the service operates and responds to input information. Such service interfaces or schemas are often subject to change (e.g., a new operation is added or an operation's response is extended by adding an element) at one or more times during the development lifecycle of an application. For such changes, simulation models of affected virtualized services are affected accordingly. Some prior techniques for updating virtualized services involve replacing a schema with a new schema and building a new simulation model from the new schema (e.g., an updated or replacement service schema), which results in losing previously collected data. Such loss of data is typically very costly. Some prior techniques involve a user modifying an existing or original simulation model by hand (e.g., if the simulation model is easily modifiable such as if it contains scripts or a set of XML responses). However, this can be quite costly in terms of required technical expertise and time to perform such changes by hand. As such, prior techniques of updating virtualized services significantly diminish the cost-saving advantages of using virtualization tools due to the expense of maintaining virtualized environments when implementing service interface changes (e.g., implementing changes from new service schemas).

Examples disclosed herein are useful to maintain cost-advantages of using virtualized environments, even when service schemas associated with such virtualized environments are changed often. Unlike prior techniques that update virtualized services by wholly replacing original service schemas with new service schemas, examples disclosed herein perform node-by-node comparisons between original service schemas (e.g., existing or active service schemas) and new service schemas (e.g., updated or replacement service schemas) without user intervention to identify changes and types of changes made in the new service schemas relative to respective original service schemas. Examples disclosed herein specify changes as transformations that are subsequently applied without user intervention to corresponding original simulation models of respective virtualized services while maintaining data associations (e.g., some, most, or all) between nodes of updated simulation models and data previously collected in association with the corresponding original simulation models.

Examples disclosed herein may be used to automatically apply service schematic changes (or service interface changes) to virtualized services without user intervention in making those changes. Thus, examples disclosed herein may be used with systems in which virtualized services are updated often without incurring the relatively higher costs associated with updating virtualized services using prior techniques. In addition, examples disclosed herein prevent or reduce instances of losing previously recorded data and/or user-supplied data corresponding to existing nodes of the virtualized services. In some examples, virtualized services having simulation models that are data oriented and declarative (e.g., simulation models that use structures similar to an extensible markup language (XML) structure of incoming/outgoing messages) facilitate making service schema changes to such virtualized services.

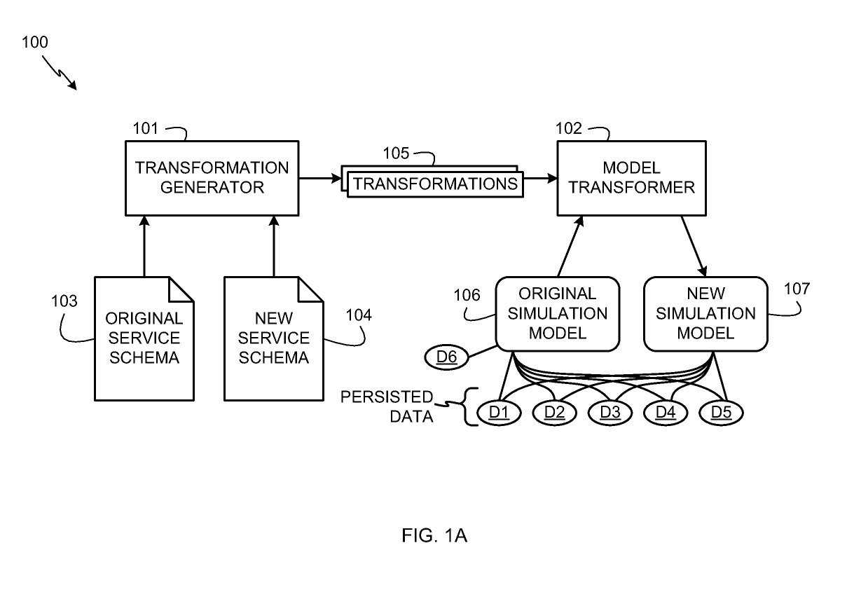

FIG. 1A is a block diagram of an example apparatus 100 including a transformation generator 101 and a model transformer 102 to analyze service schemas 103 and 104 and update corresponding virtualized services based on changes in the analyzed service schemas 103 and 104.

In the illustrated example, an original (or existing) simulation model 106 implements a virtualized service and includes recorded messages and/or data, user-supplied data, etc. In the illustrated example, the original simulation model 106 may additionally or alternatively be connected to one or more external data source storing data corresponding to the original simulation model 106. In the illustrated example, the original simulation model 106 is built based on an original (or existing or active) service schema 103. A new (or updated or replacement) service schema 104 of the illustrated example describes or defines changes (e.g., modifications or updates) to the interface of the virtualized service corresponding to the original simulation model 106. In the illustrated examples, the original service schema 103 is an existing or active service schema (e.g., that may have been previously changed from a prior service schema or that may not have been changed before). The new service schema 104 of the illustrated example is an updated or replacement service schema having changes or updates to nodes of the original service schema 103, removes nodes from the original service schema 103, and/or adds nodes not present in the original service schema 103. In the illustrated examples, the term “original” used in connection with the service schema 103 and/or the simulation model 106, and the term “new” used in connection with the service schema 104 and/or the simulation model 107 are relative terms. That is, the original service schema 103 is original (or first in time) relative to the new service schema 104, and the original simulation model 106 is original (or prior in time) relative to the new simulation model 107. Similarly, the new service schema 104 is provided after (or later in time) relative to the original service schema 103, and the new simulation model 107 is created after (or later in time) relative to the original simulation model 106.

In the illustrated example, the service schemas 103 and 104 are implemented using tree structure hierarchies having root nodes at the highest hierarchical levels and branches leading therefrom to other nodes. Some of the lower-level nodes are complex nodes that have further child nodes, while other lower-level nodes are simple nodes that do not have further child nodes. Examples disclosed herein comparatively analyze nodes between the original service schema 103 and the new service schema 104 that are at the same hierarchical level to find matching and partially matching nodes. The service schemas 103 and 104 may be implemented using Web Services Description Language (WSDL) files, XML Schema Definition (XSD) files, or any other suitable type of files. When WSDL files are used to define service schemas, changes to the service schemas can be made at different levels. For example, ports (e.g. a port's uniform resource locator (URL)) can be added, removed, and/or changed; operations can be added and/or removed; messages (e.g., fault messages) can be added and/or removed; simple and/or complex elements can be added, removed, renamed, moved, and/or type-changed; and attributes can be added, removed, renamed, moved, and/or type-changed. XSD files have relatively simpler structures (e.g., they have no concept of operation) than WSDL files and, as such, changes to XSD-based service schemas are relatively easier to implement because the changes are categorized as fewer types of changes or modifications relative to types of changes that can be made in WSDL-based service schemas.

In the illustrated example of FIG. 1A, the new service schema 104 is provided (e.g., by a program or a user) to add, remove, and/or modify one or more nodes, operations, messages, elements, definitions, parameters, etc. of the original service schema 103. When the new service schema 104 is provided, the transformation generator 101 of the illustrated example compares the new service schema 104 and the original service schema 103 to determine or identify nodes, operations, messages, elements, definitions, parameters, etc. that were added, removed, and/or modified. Based on the identified additions, removals, and/or modifications in the new service schema 104 relative to the original service schema 103, the transformation generator 101 of the illustrated example generates a list of transformations 105 indicative of such changes to be applied to the original simulation model 106 to build a new simulation model 107. The new simulation model 107 of the illustrated example corresponds to the updated version of the virtualized service as intended by the changes in the new service schema 104.

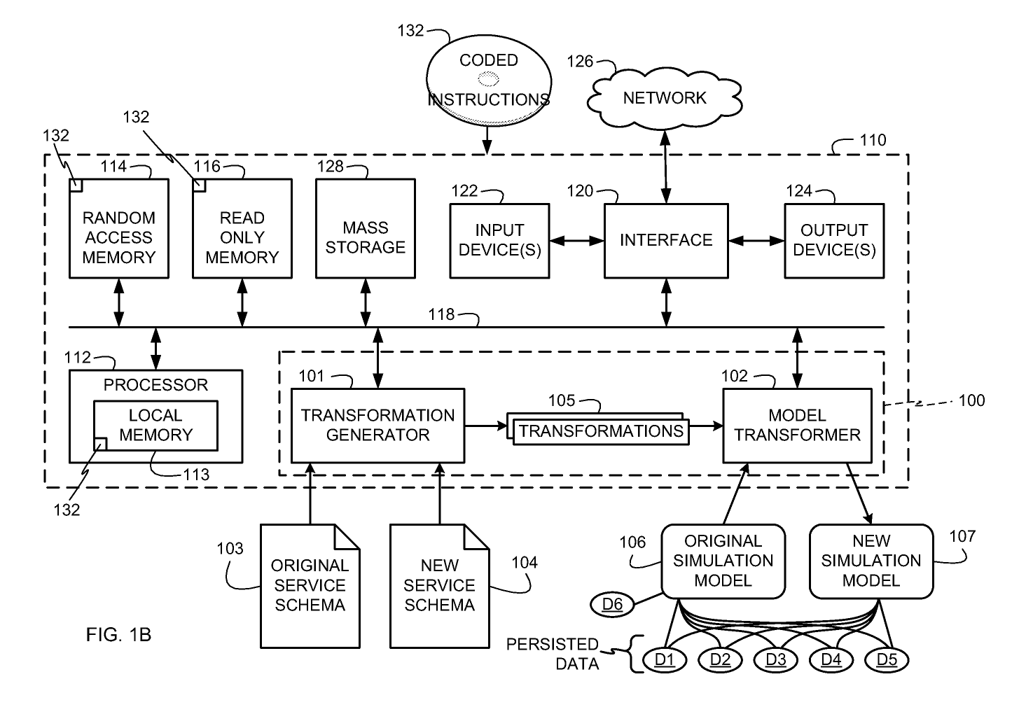

As discussed above, prior techniques of updating service interfaces or service schemas of virtualized services involve wholly replacing a service schema (e.g., the original service schema 103) with a new service schema (e.g., the new service schema 104) and building a new simulation model from the new service schema, or involve a user modifying an existing or original simulation model by hand. However, such prior techniques result in losing all previously collected data associated with nodes of the original service schema when the original service schema is wholly replaced and/or are costly to implement due to required time and/or expertise. To prevent or reduce instances of such data loss, the transformation generator 101 of the illustrated example analyzes the original service schema 103 in comparison to the new service schema 104 on a node-by-node basis based on one or more different criteria to specifically identify particular nodes (e.g., operations, messages, elements, attributes, etc.) that are added, removed, and/or modified, and to distinguish such changes from particular nodes that are not changed (e.g., added, removed, and/or modified). In this manner, the transformation generator 101 can generate the transformations 105 and specify therein the identified changes for portions of the original service schema 103 that are to be changed based on the new service schema 104 without needing to specify changes to portions of the original service schema 103 that are not to be changed. Examples of different criterion-based analyses are described below in connection with FIGS. 2-6.

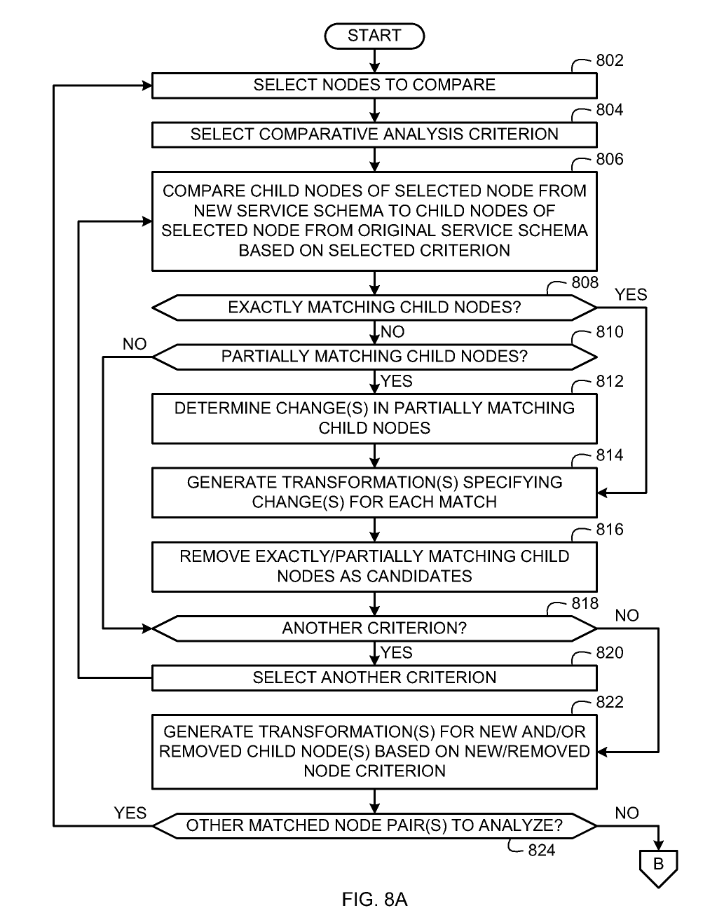

In the illustrated example, the model transformer 102 updates the original simulation model 106 based on the transformations 105 by updating only parts of the original simulation model 106 corresponding to changes identified in the new service schema 104 as described by the transformations 105 and keeping unchanged portions of the original service schema 103 intact. In this manner, previously collected data and/or user-supplied data of the original simulation model 106 that corresponds to unchanged nodes or partially changed nodes of the original service schema 103 is maintained or persisted. For example, the original simulation model 106 of FIG. 1A includes collected and/or user-supplied data D1, D2, D3, D4, D5, and D6. After the model transformer 102 applies the transformations 105 to the original simulation model 106 resulting in the new simulation model 107, only the data D6 is lost (e.g., the data D6 corresponds to a removed node for which previous data cannot be maintained), but the data D1-D5 are persisted (e.g., persisted or maintained data associations) to the new simulation model 107 because they correspond to portions of the new simulation model 107 that were not removed. However, some of the data D1-D5 may have changed to correspond to modifications in the new service schema 104. Examples of the original simulation model 106 and the new simulation model 107 and their respective data associations are described below in connection with FIG. 7.

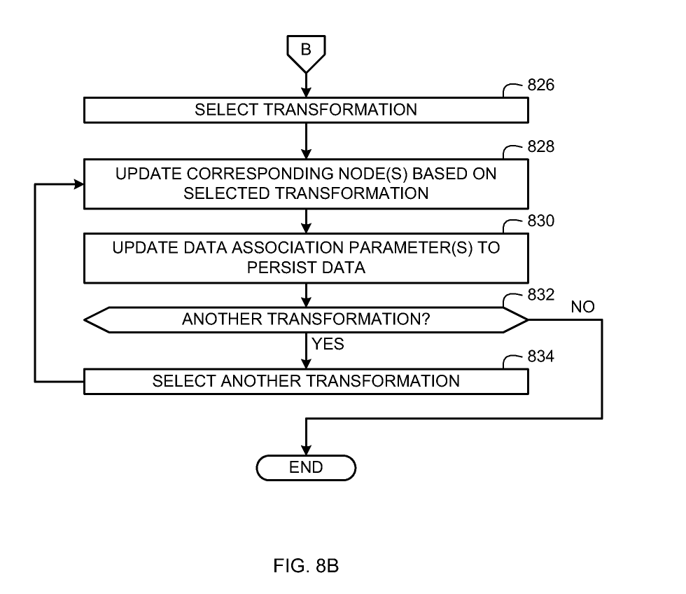

FIG. 1B illustrates an example computer 110 that can be used to execute example instructions of FIGS. 8A and 8B to implement the example apparatus 100 of FIG. 1A to analyze the service schemas 103 and 104 and update corresponding virtualized services based on changes in the analyzed service schemas 103 and 104. In the illustrated example of FIG. 1B, the example apparatus 100 is shown in the context of the computer 110. In some examples, the computer 110 may implement the apparatus 100 using hardware, firmware, software, and/or any combination thereof. The computer 110 may be implemented using, for example, a server, a personal computer, or any other type of computing device.

In the illustrated example of FIG. 1B, the computer 110 includes an example processor 112 that may be implemented using one or more microprocessors or controllers from any suitable family or manufacturer. The processor 112 of the illustrated example includes a local memory 113 (e.g., a cache) and is in communication with a main memory including a volatile memory 114 and a non-volatile memory 116 via a bus 118. The volatile memory 114 may be implemented using Synchronous Dynamic Random Access Memory (SDRAM), Dynamic Random Access Memory (DRAM), RAMBUS Dynamic Random Access Memory (RDRAM) and/or any other type of random access memory device. The non-volatile memory 116 may be implemented using flash memory and/or any other desired type of memory device. Access to the main memory 114, 116 is controlled by a memory controller. In the illustrated example, any one or more of the memories of the computer 110 may be used to store the original service schema 103, the new service schema 104, the original simulation model 106, and/or the new simulation model 107.

The computer 110 also includes an interface circuit 120. The interface circuit 120 may be implemented using any suitable type of interface standard, such as an Ethernet interface, a universal serial bus (USB), and/or a PCI express interface. In the illustrated example, the interface circuit 120 also includes a communication device such as a modem or network interface card to facilitate exchange of data with external computers via a network 126 (e.g., an Ethernet connection, a digital subscriber line (DSL), a telephone line, coaxial cable, a cellular telephone system, etc.). In some examples, the apparatus 100 receives the original service schema 103 and/or the new service schema 104 via the interface circuit 120.

In the illustrated example, one or more input device(s) 122 are connected to the interface circuit 120. The input device(s) 122 of the illustrated example permit a user to enter data and/or commands into the processor 112. The input device(s) 122 of the illustrated example can be implemented using, for example, a keyboard, a mouse, a touchscreen, a track-pad, a trackball, isopoint and/or a voice recognition system.

In the illustrated example, one or more output device(s) 124 are also connected to the interface circuit 120. The output devices 124 can be implemented using, for example, display devices (e.g., a liquid crystal display, a cathode ray tube display (CRT), a printer and/or speakers). The interface circuit 120 of the illustrated example, thus, typically includes a graphics driver card.

The computer 110 of the illustrated example also includes one or more mass storage devices 128 for storing software and/or data. Examples of such mass storage devices 128 include floppy disk drives, hard drive disks, compact disk drives and digital versatile disk (DVD) drives.

Coded machine readable instructions 132 of the illustrated example may be stored in the mass storage device 128, in the volatile memory 114, in the non-volatile memory 116, and/or on a removable storage medium such as a compact disk (CD) or a digital versatile disk (DVD).

Although the transformation generator 101 and the model transformer 102 are shown in FIG. 1B separate from the processor 112, in some examples, the coded machine readable instructions 132, when executed by the processor 112, implement one or both of the transformation generator 101 and the model transformer 102.

While an example manner of implementing the apparatus 100 has been illustrated in FIGS. 1A and 1B, one or both or portions of the transformation generator 101 and the model transformer 102 may be combined, divided, re-arranged, omitted, eliminated and/or implemented in any other suitable way. Further, the example transformation generator 101, the example model transformer 102 and/or, more generally, the example apparatus 100 of FIGS. 1A and 1B may be implemented using hardware, software, firmware and/or any combination of hardware, software and/or firmware. Thus, for example, either of the example transformation generator 101 and the example model transformer 102 and/or, more generally, the example apparatus 100 could be implemented using one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example transformation generator 101 and/or the example model transformer 102 are hereby expressly defined to include a tangible computer readable medium such as a memory, DVD, CD, Blu-ray, etc. storing the software and/or firmware. Further still, the example apparatus 100 of FIGS. 1A and 1B may include one or more elements, processes and/or devices in addition to, or instead of, the transformation generator 101 and/or the model transformer 102 illustrated in FIGS. 1A and 1B, and/or may include more than one of the transformation generator 101 and/or more than one of the model transformer 102 of the illustrated example.

FIGS. 2-6 illustrate results of example criteria-based analyses performed by the transformation generator 101 of FIGS. 1A and 1B on the original service schema 103 and the new service schema 104 of FIGS. 1A and 1B to identify transformations to be applied to the original simulation model 106 to create the new simulation model 107 of FIGS. 1A and 1B. Each of FIGS. 2-6 shows an example comparative analysis performed by the transformation generator 101 based on a respective criterion. In the illustrated examples, the transformation generator 101 compares a node of the original service schema 103 to a node of the new service schema 104 at any given time, starting with the root nodes of the service schemas 103 and 104. In the illustrated examples, the transformation generator 101 analyzes the contents (e.g., child nodes) of each node, and divides the results from the comparative analyses into three groups including a matching nodes group, a new nodes group, and a removed nodes group. In the illustrated examples, the matching nodes group includes nodes considered to match between the original service schema 103 and the new service schema 104. In the illustrated examples, nodes in the matching nodes group need not wholly match (e.g., have all of the same content) between the original service schema 103 and the new service schema 104. That is, some nodes in the matching nodes group can differ in some of their properties (e.g. a name property, a type property, a position property, etc.) but have at least some of these properties that match between the schemas 103 and 104. For example, a node may be located in the matching nodes group if it is represented in the original service schema 103 and the new service schema 104 using different data types (e.g., an int data type in the original service schema 103 and a string data type in the new service schema 104). In some examples, some or all child nodes of parent matching nodes also match between the schemas 103 and 104, while in other examples none of the child nodes match even though the parent nodes do match. In the illustrated examples, the new nodes group includes nodes that have been added to a service schema, for example, by appearing in the new service schema 104 but not existing in the original service schema 103. In the illustrated examples, the removed nodes group includes nodes that have been removed from a service schema, for example, by not appearing in the new service schema 104 but existing in the original service schema 103.

In the illustrated examples, the transformation generator 101 generates “add” transformations 105 for new nodes and “remove” transformations 105 for removed nodes. For the matching nodes group, the transformation generator identifies pairs of nodes, each pair including a node from the original service schema 103 and a corresponding matching node from the new service schema 104. For matching nodes (exactly or partially) that are complex nodes (e.g., they have further child nodes), their child nodes are compared between the schemas 103 and 104 to find matching nodes (exactly or partially). For nodes of the new service schema 104 categorized in the matching nodes group and having some properties different from their corresponding nodes in the original service schema 103, the transformation generator 101 of FIGS. 1A and 1B generates corresponding transformations 105 to specify the new or changed contents or properties (e.g., new names of renamed elements or child nodes). In the disclosed examples, to maintain or persist as much data (e.g., data D1-D5 of FIGS. 1A and 1B) as possible from the original simulation model 106 to the new simulation model 107, the transformation generator 101 uses exact matching and partial matching (e.g., a partial matching algorithm) during comparative analyses to find matching nodes between the original service schema 103 and the new service schema 104. In this manner, as many nodes and data as possible are maintained from the original service schema 103 when the new service schema 104 is implemented.

In the illustrated examples, each of FIGS. 2-6 represents a result from a respective comparative analysis performed by the transformation generator 101 using a respective criterion. In the illustrated examples, at different node levels (e.g., a service level, a port level, a binding level, a port type level, an operation level, a message level, complex element levels, simple element/attribute levels, etc.) different criteria may be used because properties may differ between node levels. In some examples, analyzing complex type elements may involve relatively more processing due to the quantity of child nodes stored therein. A complex element contains a list of child nodes or elements. Three attributes of a child node shown in FIGS. 2-6 include a name attribute, a type attribute, and position attribute. To perform the matching algorithm, the transformation generator 101 defines child node positions as sequence numbers among the child nodes of the same parent (or root node). However, any other suitable definitions may be used instead (e.g., if a new element is added a different sequence may be defined).

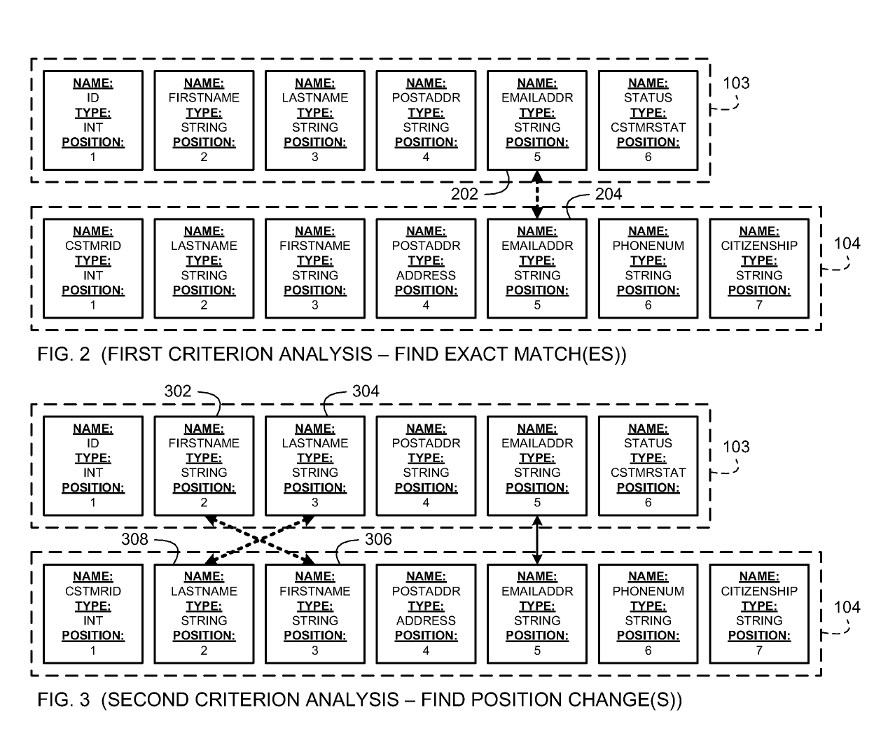

In the illustrated examples, the transformation generator 101 comparatively analyzes the original service schema 103 and the new service schema 104 by performing multiple iterations of a matching algorithm, each time using a different criterion. In the illustrated examples, the transformation generator 101 starts the comparative analyses using the most restrictive matching criterion first (e.g., exact matching), shown in FIG. 2, followed by progressively less restrictive matching criterion shown in FIGS. 3-6. In the illustrated examples, dashed lines between original service schema nodes and new service schema nodes denote results based on a criterion for the respective figure, and solid lines between original service schema nodes and new service schema nodes denote results from previous criterion.

FIG. 2 illustrates a comparative analysis result based on an exact match criterion for which the transformation generator 101 finds nodes in the new service schema 104 having matching names, types, and positions with nodes in the original service schema 103. In the illustrated example of FIG. 2, the transformation generator 101 determines that node 202 of the original service schema 103 exactly matches node 204 of the new service schema 104. In the exact match of FIG. 2, the transformation generator 101 determined that all properties (e.g., name, type, and position) of the root node 202 exactly matched all properties of the node 204.

FIG. 3 illustrates a comparative analysis result based on a position change criterion for which the transformation generator 101 finds nodes in the new service schema 104 having matching names and types with nodes in the original service schema 103 but different positions. In the illustrated example of FIG. 3, the transformation generator 101 determines that nodes 302 and 304 of the original service schema 103 were transposed in the new service schema 104 such that node 302 at position 2 in the original service schema 103 corresponds to node 306 at position 3 in the new service schema 104 and node 304 at position 3 in the original service schema 103 corresponds to node 308 at position 2 in the new service schema 104. In the illustrated example of FIG. 3, the transformation generator 101 determines that the position-changed nodes correspond to one another based on nodes having exactly matching names and types but different positions.

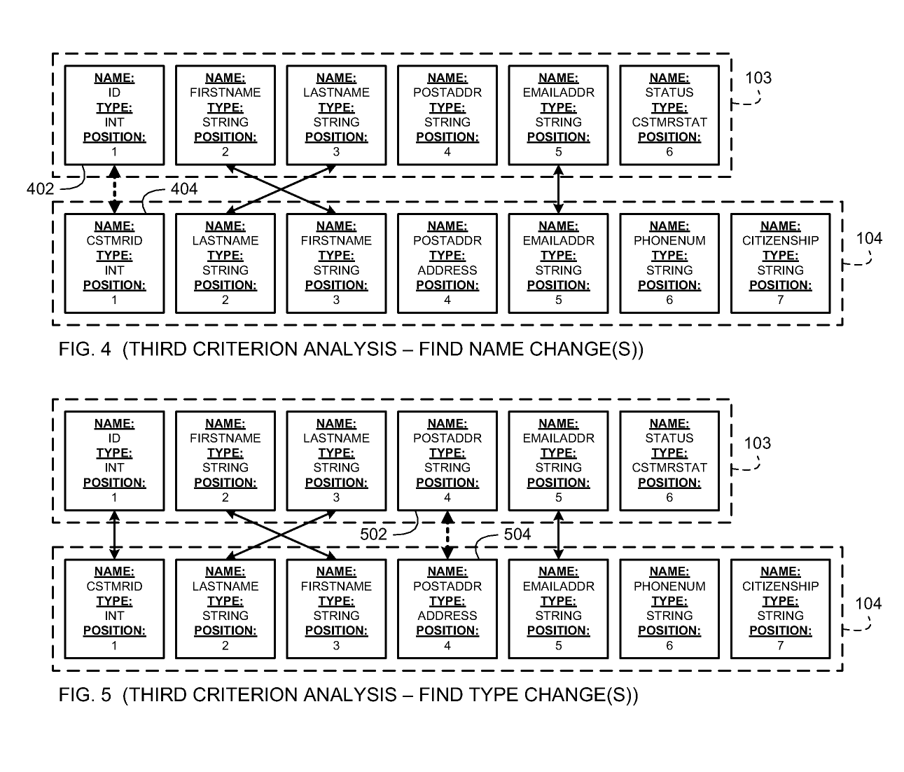

FIG. 4 illustrates a comparative analysis result based on a name change criterion for which the transformation generator 101 finds nodes in the new service schema 104 having matching types and positions with nodes in the original service schema 103 but different names. In the illustrated example of FIG. 4, the transformation generator 101 determines that node 402 of the original service schema 103 and node 404 of the new service schema 104 have matching types and positions but have different names.

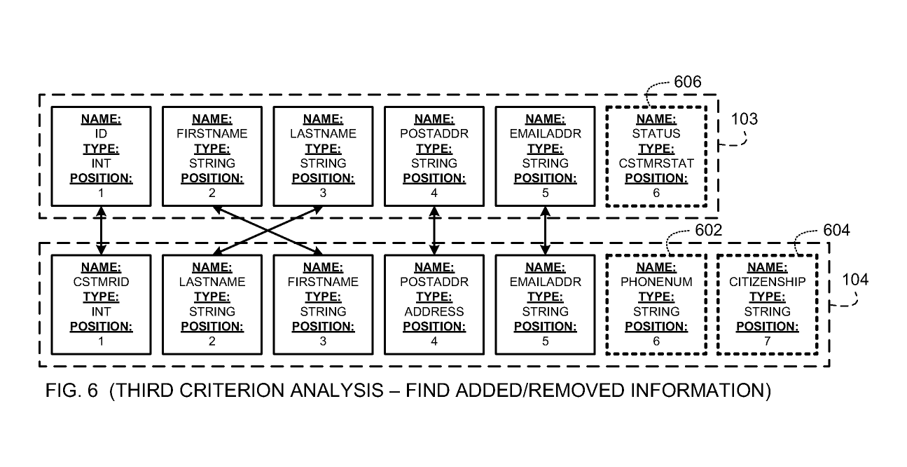

FIG. 5 illustrates a comparative analysis result based on a type change criterion for which the transformation generator 101 finds nodes in the new service schema 104 having matching names and positions with nodes in the original service schema 103 but different types. In the illustrated example of FIG. 5, the transformation generator 101 determines that root node 502 of the original service schema 103 and node 504 of the new service schema 104 have matching names and positions but have different types.

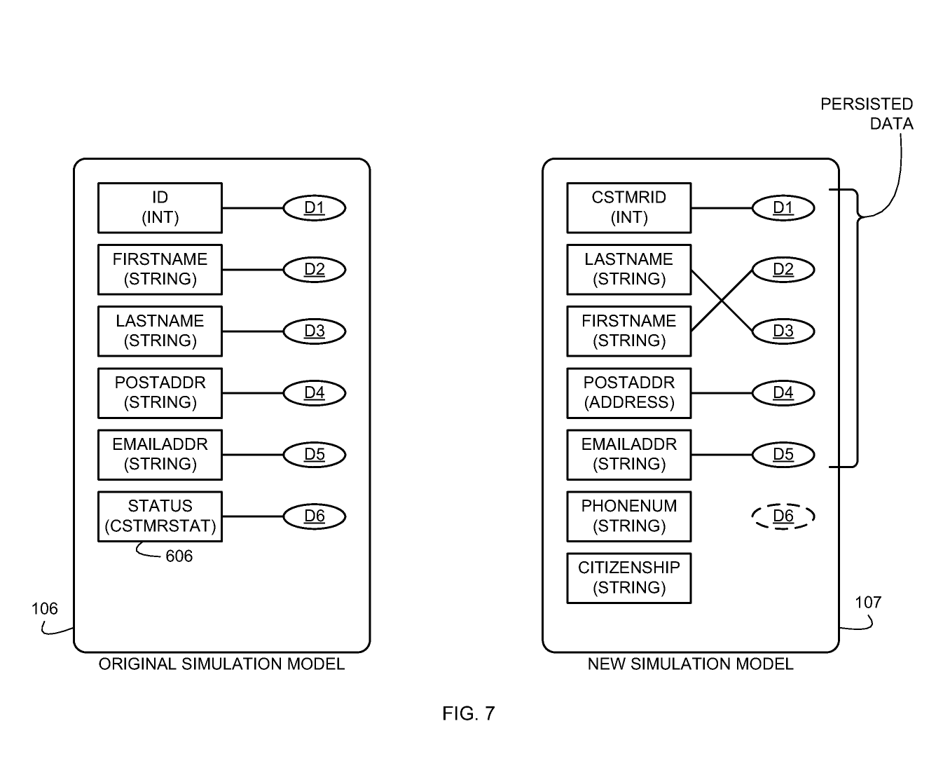

Each time the transformation generator 101 of the illustrated example finds a match (exact or partial match), it removes both matching nodes as candidate nodes from the original service schema 103 and the new service schema 104 so that such already matched nodes are not considered by the transformation generator 101 during subsequent comparative analyses. When all of the criterion-based comparative analyses iterations are finished, candidate nodes remaining in the new service schema 104 include nodes that didn't match (e.g., neither an exact match or a partially match) any nodes in the original service schema 103. In the illustrated examples, the transformation generator 101 denotes such remaining candidate nodes in the new service schema 104 as newly added nodes relative to the original service schema 103. FIG. 6 shows example newly added nodes 602 and 604. In addition, the transformation generator 101 determines that candidate nodes remaining in the original service schema 103 for which no matches (no exact or partial matches) were found in the new service schema 104 are removed nodes relative to the original service schema 103. FIG. 6 shows an example removed node 606.

In the illustrated example, the transformation generator 101 generates a transformation 105 (FIGS. 1A and 1B) for each of the partially matched node pairs of FIGS. 2-5 first, and then the transformation generator 101 generates transformations 105 for each newly added node 602 and 604 in FIG. 6 and for the removed node 606 of FIG. 6. In some implementations, the transformation generator 101 may generate a transformation 105 for each exactly matched node pair. For matching nodes (exactly matching or partially matching nodes) that are complex nodes (e.g., they have further child nodes), their child nodes are compared between the schemas 103 and 104 to find matching child nodes (exactly matching or partially matching child nodes) and to generate respective transformations 105 for any child nodes found to match or partially match between the schemas 103 and 104. In this manner, the model transformer 102 can apply the transformations 105 to the original simulation model 106 of FIGS. 1A and 1B to effectuate the changes of the new service schema 104 automatically and/or without user intervention on a node-by-node basis to generate the new simulation model 107 of FIGS. 1A and 1B.

FIG. 7 illustrates an example manner in which the model transformer 102 may update the original simulation model 106 of a virtualized service to generate the new simulation model 107 based on the transformations 105. By applying node-by-node changes instead of wholly replacing the original service schema 103 with the new service schema 104, the model transformer 102 enables persisting or maintaining as much previously collected data (e.g., the data D1-D5) with the new simulation model 107 as possible. For example, in the illustrated examples of FIGS. 1A and 1B, the data D1-D5 from the original simulation model 106 are persisted or maintained with the new simulation model 107. Using prior techniques of wholly replacing the original service schema 103 with the new service schema 104 would result in losing all of the data D1-D6. In the illustrated example of FIG. 7, only the data D6 is lost because the corresponding node 606 does not appear in the new service schema 104 (as shown in FIG. 6) and, thus, is removed. In the illustrated examples, the model transformer 102 can persist the data D1-D5 by modifying data association information, parameters, or properties to correspond with the node changes (e.g., name parameters, data type parameters, position parameters, etc.) indicated in the transformations 105 for nodes corresponding to the data D1-D5. In this manner, by updating the data association parameters or properties of the data D1-D5 to match the properties of their corresponding nodes, the data D1-D5 is persisted with their corresponding nodes in the new simulation model 107.

FIGS. 8A and 8B depict a flow diagram representative of example machine readable instructions to implement the transformation generator 101 and the model transformer 102 of FIGS. 1A and 1B. The example method of FIGS. 8A and 8B may be used to comparatively analyze nodes between original and new service schemas (e.g., the original service schema 103 and the new service schema 104 of FIGS. 1A and 1B) and update a corresponding virtualized service (e.g., a virtualized service corresponding to the original simulation model 106 of FIGS. 1A and 1B) based on changes between the original and new service schemas. In this example, the machine readable instructions comprise a program for execution by a processor such as the processor 112 shown in the example computer 110 discussed above in connection with FIG. 1B. The program may be embodied in software stored on a tangible computer readable medium such as a CD-ROM, a floppy disk, a hard drive, a digital versatile disk (DVD), a Blu-ray disk, or a memory associated with the processor 112, but the entire program and/or parts thereof could alternatively be executed by a device other than the processor 112 and/or embodied in firmware or dedicated hardware. Further, although the example program is described with reference to the flowchart illustrated in FIGS. 8A and 8B, many other methods of implementing the example transformation generator 101 and the model transformer 102 may alternatively be used. For example, the order of execution of the blocks may be changed, and/or some of the blocks described may be changed, eliminated, or combined.

As mentioned above, the example processes of FIGS. 8A and 8B may be implemented using coded instructions (e.g., computer readable instructions) stored on a tangible computer readable medium such as a computer readable storage medium (e.g., a hard disk drive, a flash memory, a read-only memory (ROM), a compact disk (CD), a digital versatile disk (DVD), a cache, a random-access memory (RAM)) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 8A and 8B may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The example method of FIGS. 8A and 8B starts when the transformation generator 101 selects nodes to compare between the original service schema 103 and the new service schema 104 (block 802) (FIG. 8A). For example, the transformation generator 101 selects a node from the original service schema 103, and a node at the same tree structure hierarchy level in the new service schema 104 to compare with the selected node from the original service schema 103. During an initial iteration, a root node of a tree structure hierarchy is selected, and during subsequent iterations lower-level complex and/or simple nodes of the tree structure hierarchy are selected.

The transformation generator 101 selects a comparative analysis criterion (block 804). In the illustrated example, the transformation generator 101 selects the most restrictive criterion first, which is an exact match criterion for which all properties of a node of the original service schema 103 must match with a corresponding node of the new service schema 104 to qualify as an exact match. During subsequent comparative analyses of the nodes selected at block 802, the transformation generator 101 selects other criterion (e.g., a position change criterion, a name change criterion, a type change criterion, an added node criterion, a removed node criterion, etc.) that are less restrictive and, thus, can find partial matches between nodes of the schemas 103 and 104.

The transformation generator 101 compares child nodes of the selected node from the new service schema 104 to child nodes of the selected node from the original service schema 103 based on the selected criterion (block 806) as, for example, described above in connection with FIGS. 2-6. The transformation generator 101 determines whether it found any exactly matching child nodes (block 808) such as the nodes 202 and 204 of FIG. 2. If at block 808 the transformation generator 101 does find one or more exact matches, control advances to block 814. Otherwise, the transformation generator 101 determines whether it found any partially matching child nodes (block 810). Although block 810 would not yield any partial match results when an exact match criterion is selected at block 804, block 810 may yield one or more partial match results when other match criteria (e.g., a position change criterion, a name change criterion, a type change criterion, etc.) are selected as described above in connection with FIGS. 3-5.

For examples in which the nodes selected at block 802 are simple nodes (e.g., the selected nodes do not have child nodes), blocks 808 and 810 can result in only one pair of matching nodes between the schemas 103 and 104, corresponding to the selected simple node of the original service schema 103 and the selected simple node of the new service schema 104. For examples in which the nodes selected at block 802 are complex nodes (e.g., the selected nodes have child nodes), blocks 808 and 810 may result in one or more pairs of matching child nodes between the schemas 103 and 104. That is, when complex nodes are selected at block 802, the comparison of block 806 compares child nodes of the selected complex nodes to one another.

In some examples, blocks 808 and 810 may be combined into a single operation determining whether any exactly or partially matching nodes are found based on the criterion selected at block 806. In such examples, when such matches are found, control advances to block 812. Otherwise, control advances to block 818.

In the illustrated example, if at block 810 no partial matches are found, control advances to block 818. Otherwise, the transformation generator 101 determines one or more change(s) in the partially matching child nodes (block 812). For example, the transformation generator 101 may identify a name change, a data type change, a position change, etc. The transformation generator 101 generates one or more transformation(s) 105 (FIGS. 1A and 1B) to specify change(s) for each match (block 814). In some implementations, the transformation generator 101 may generate transformations 105 for both exactly matching and partially matching child node pairs. In other implementations, the transformation generator 101 may generate transformations 105 for partially matching child node pairs, but not for exactly matching child node pairs. The transformation generator 101 removes the exactly matching or partially matching child node(s) as candidates from the schemas 103 and 104 (block 816).

The transformation generator 101 determines whether there is another criterion for which to perform a comparative analysis (block 818). If there is another criterion (block 818) (e.g., a position change criterion, a name change criterion, a type change criterion, an added node criterion, a removed node criterion, etc.), the transformation generator 101 selects another criterion (block 820). Control then returns to block 806 to perform another iteration of the comparative analysis on the selected child nodes based on the newly selected criterion

If at block 818 there is not another criterion left for which to perform a comparative analysis, the transformation generator 101 generates one or more transformation(s) 105 to specify each added and/or removed child node based on a new/removed criterion (block 822). In the illustrated example, the transformation generator 101 performs the operation of block 822 based on a newly added node(s) criterion and/or a removed child node(s) criterion (e.g., described above in connection with FIG. 6) to identify and generate transformations for one or more newly added child node(s) and/or one or more removed child node(s).

The transformation generator 101 determines whether there is/are one or more other matched node pair(s) of the schemas 103 and 104 to compare (block 824). In the illustrated example, matched node pair(s) found at block 808 and/or block 810 can be further analyzed to compare their child nodes. For example, the example process of FIG. 8A may be repeated for each matching node pair found at block 808 and/or block 810 at different child node levels of hierarchical tree structures in the service schemas 103 and 104. In this manner, the FIG. 8A process may be used to drill down to various child node levels to identify matching nodes (exactly matching nodes at block 808 or partially matching at block 810) at different levels of a hierarchical tree structure. If there is/are one or more other matched node pair(s) to analyze (block 824) control returns to block 802, at which the next node pair is selected (e.g., at the same child node level or a different child node level).

If there is/are no other matched node pair(s) to analyze (block 824), control advances to block 826 of FIG. 8B. In the illustrated example, the comparative analyses of FIG. 8A of the nodes of the service schemas 103 and 104 are performed automatically and without user intervention. In some examples, the transformation generator 101 performs the comparative analyses automatically when it receives the new service schema 104 from a user (e.g., the user enters a uniform resource locator (URL) or other location information identifying where the new service schema 104 is stored). In other examples, a user may select an “analyze” button or provide other similar user input to cause the transformation generator 101 to comparatively analyze the schemas 103 and 104. In either case, the node-by-node comparisons and the detecting of exact matches, partial matches, added nodes, and/or removed nodes are performed by the transformation generator 101 automatically and without user intervention.

After or while the transformations 105 are generated by the transformation generator 101, the model transformer 102 applies the transformations 105 to the original simulation model 106 to generate the new simulation model 107 for a corresponding virtualized service without user intervention. In some examples, a user may select an “apply” button or provide other similar user input to cause the model transformer 102 to apply the transformations 105. In other examples, the model transformer 102 applies the transformations 105 when the transformation generator 101 makes them available without needing a user-input to initiate the process of applying the transformations 105. In either case, the process of applying the transformations 105 to generate the new simulation model 107 as described below is performed by the model transformer 102 automatically and without user intervention. Referring to the illustrated example of FIG. 8B, the model transformer 102 (FIGS. 1A and 1B) selects a transformation 105 (block 826). The model transformer 102 updates one or more corresponding node(s) of the original simulation model 106 based on the selected transformation (block 828). The model transformer 102 also updates data association parameter(s) or property(ies) (block 830) of previously collected or user-supplied data (e.g., the data D1-D5 of FIGS. 1A, 1B, and 7) based on the selected transformation 105 to persist the data in the new simulation model 107 for nodes updated at block 828. The model transformer 102 determines whether there is another transformation 105 to process (block 832). If there is another transformation 105 to process (block 832), the model transformer 102 selects another transformation 105 (block 834), and control returns to block 828. In this manner, the model transformer 102 may repeat blocks 828, 830, 832, and 834 until all of the transformations 105 have been applied to the original simulation model 106 to create the new simulation model 107 with any node changes, node additions, and/or node removals detected using the comparative analyses of FIG. 8A. When there is not another transformation 105 to process (block 832), the example method of FIGS. 8A and 8B ends.

Although the above discloses example methods, apparatus, and articles of manufacture including, among other components, software executed on hardware, it should be noted that such methods, apparatus, and articles of manufacture are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the above describes example methods, apparatus, and articles of manufacture, the examples provided are not the only way to implement such methods, apparatus, and articles of manufacture. Thus, although certain methods, apparatus, and articles of manufacture have been described herein, the scope of coverage of this patent is not limited thereto. To the contrary, this patent covers all methods, apparatus, and articles of manufacture fairly falling within the scope of the claims either literally or under the doctrine of equivalents.

What is claimed is:

1. A method to update a virtualized service, the method comprising:
comparing at least one node of a first service schema to at least one node of a second service schema based on at least one criterion;
finding at least one change in the at least one node of the second service schema relative to the at least one node of the first service schema based on the at least one criterion; and
updating a first node of a first virtualized service with a processor and without user intervention based on the at least one change while maintaining an association between the first node of the first virtualized service and data previously associated with the first node.

2. A method as defined in claim 1, wherein the data previously associated with the first node includes at least one of data previously recorded by the first node or data previously supplied by a user for the first node.

3. A method as defined in claim 1, wherein each of the at least one node of the first service schema and the at least one node of the second service schema comprises child nodes, and wherein comparing the at least one node of the first service schema and the at least one node of the second service schema comprises comparing ones of the child nodes corresponding to the first service schema with ones of the child nodes corresponding to the second service schema.

4. A method as defined in claim 1, wherein the at least one criterion includes at least one of an exact match criterion, a position change criterion, a name change criterion, a type change criterion, an added node criterion, or a removed node criterion.

5. A method as defined in claim 1, further comprising updating data association parameters of the data to maintain the association between the first node and the data.

6. An apparatus to update a virtualized service, the apparatus comprising:
a transformation generator to:
compare at least one node of a first service schema to at least one node of a second service schema based on at least one criterion, and
find at least one change in the at least one node of the second service schema relative to the at least one node of the first service schema based on the at least one criterion; and
a model transformer to update a first node of a first virtualized service without user intervention based on the at least one change while maintaining an association between the first node of the first virtualized service and data previously associated with the first node.

7. An apparatus as defined in claim 6, wherein the data previously associated with the first node includes at least one of data previously recorded by the first node or data previously supplied by a user for the first node.

8. An apparatus as defined in claim 6, wherein each of the at least one node of the first service schema and the at least one node of the second service schema comprises child nodes, and wherein the transformation generator is to compare the at least one node of the first service schema and the at least one node of the second service schema by comparing ones of the child nodes corresponding to the first service schema with ones of the child nodes corresponding to the second service schema.

9. An apparatus as defined in claim 6, wherein the at least one criterion includes at least one of an exact match criterion, a position change criterion, a name change criterion, a type change criterion, an added node criterion, or a removed node criterion.

10. An apparatus as defined in claim 6, wherein the model transformer is further to update data association parameters of the data to maintain the association between the first node and the data.

11. An apparatus to update a virtualized service, comprising:
a transformation generator to:
perform a first comparative analysis to find exact matches between first nodes of a first service schema and second nodes of a second service schema, and
generate at least a first transformation based on a second comparative analysis to find partial matches between the first nodes of the first service schema and the second nodes of the second service schema; and
a model transformer to apply the first transformation to a first simulation model of a virtualized service to generate a second simulation model for the virtualized service.

12. An apparatus as defined in claim 11, wherein a partial match comprises a different name, a different data type, or a different position between one of the first nodes and a corresponding one of the second nodes.

13. An apparatus as defined in claim 11, wherein the model transformer is further to update data association properties of data corresponding to one of the first nodes to maintain the data in association with the second simulation model after applying the first transformation.

14. An apparatus as defined in claim 11, wherein generating the second simulation model results in maintaining first data in the second simulation model and losing second data, the lost second data corresponding to one of the first nodes of the first service schema that is removed by not appearing in the second service schema, and the maintained first data corresponding to one of the first nodes of the first service schema that exactly matches or partially matches one of the second nodes of the second service schema.

15. An apparatus as defined in claim 11, wherein the transformation generator is further to remove exact matching nodes from consideration during the second comparative analysis to find the partial matches.
